(19) United States
(12) Patent Application Publication
(10) Pub. No.: US 2019/0220834 A1
(43) Pub. Date: Jul. 18, 2019

(54) Bill Payment System and Method

(71) Applicant: Gelliner Limited, Douglas, Isle of Man (GB)

(72) Inventors: Martin Paul Moshal, Queens Way Quay (GI); David de Villiers, Ballito (ZA)

(21) Appl. No.: 16/334,414

(22) PCT Filed: Sep. 20, 2017
(86) PCT No.: PCT/GB2017/052807

§ 371 Date: Mar. 19, 2019

(30) Foreign Application Priority Data
Sep. 20, 2016 (GB) 1615964.2

(51) Int. Cl. G06Q 20/10; G06Q 30/04

(52) U.S. Cl. CPC G06Q 20/102; G06Q 30/04

(57) ABSTRACT

A client device may scan an encoding of a bill using a scanner. In response to scanning the encoding of the bill, the client device may decode the encoding of the bill to determine contents of the bill, including a merchant identifier and an amount due. The client device may determine whether automatic payment is enabled for the client device. If automatic payment is enabled for the client device, the client device may send to a transaction server the merchant identifier, the amount due, and details of a preselected payment instrument. If automatic payment is not enabled for the client device, then the client device may request an acceptance of the bill via a user interface and, in response to obtaining the acceptance of the bill, the client device may send to the transaction server the merchant identifier, the amount due, and details of a payment instrument.

### BACKGROUND

Bill payment at establishments such as restaurants, refuelling stations, and retailers can be tedious and time-consuming. For example, at a merchant establishment, when a customer is presented with a bill at the conclusion of a purchase, the customer may tender cash or a payment instrument (such as a credit or debit card) to the merchant in order to pay the bill. The merchant then provides change if payment is by cash, or uses a point-of-sale (“POS”) terminal if payment is via a payment instrument.

A customer can also pay a bill at an establishment using a mobile device. For example, current technology allows for bill payment by (i) scanning, using a mobile device such as a smartphone, an image, such as a quick response (“OR”) code, that encodes one or more of a merchant identification code that identifies a merchant and information relating to a bill from the merchant; (ii) decoding the scanned image to recover the encoded information; (iii) selecting a payment instrument for paying the bill; and (iv) transmitting a payment request to a payment server, the payment request including the merchant identification code, data pertaining to an amount due on the bill, and data pertaining to the selected payment instrument.

### SUMMARY

Viewed from one aspect, the disclosure provides a method performed by a client device to pay a bill from a merchant. The client device and the merchant use a transaction server to facilitate payment of the bill, and the client device includes a scanner, a network interface, and a user interface. The method includes: scanning an encoding of the bill using the scanner; in response to scanning the encoding of the bill, decoding the encoding of the bill to determine contents of the bill, wherein the contents of the bill comprise a merchant identifier and an amount due; determining whether automatic payment is enabled for the client device; if automatic payment is enabled for the client device, then, based at least in part on automatic payment being enabled for the client device, sending to the transaction server the merchant identifier, the amount due, and details of a preselected payment instrument via the network interface; and if automatic payment is not enabled for the client device, then, based at least in part on automatic payment not being enabled for the client device, (i) requesting an acceptance of the bill via the user interface and (ii) in response to obtaining the acceptance of the bill via the user interface, sending to the transaction server the merchant identifier, the amount due, and details of a payment instrument via the network interface.

Viewed from a second aspect, the disclosure provides a method performed by a client device to enable the client device to automatically pay bills from merchants. The client device includes a scanner, a network interface, and a user interface. The method includes: scanning an encoding of a bill using the scanner; in response to scanning the encoding of the bill, decoding the encoding of the bill to determine contents of the bill, wherein the contents of the bill comprise a merchant identifier and an amount due; requesting an acceptance of the bill via the user interface; in response to obtaining the acceptance of the bill via the user interface, sending to a transaction server the merchant identifier, the amount due, and details of a payment instrument via the network interface; receiving, from the transaction server via the network interface, a notification that the bill is paid; and in response to receiving the notification that the bill is paid, prompting a user of the client device via the user interface to enable automatic payment for the client device.

Viewed from a third aspect, the disclosure provides a method performed by a client device to pay a bill from a merchant. The client device and the merchant use a transaction server to facilitate payment of the bill, and the client device includes a scanner, a network interface, and a user interface. The method includes: scanning an encoding of the bill using the scanner; in response to scanning the encoding of the bill, decoding the encoding of the bill to determine contents of the bill, wherein the contents of the bill comprise a merchant identifier and an amount due; determining whether automatic payment is enabled for the client device; if automatic payment is enabled for the client device, then, based at least in part on automatic payment being enabled for the client device, sending to the transaction server the merchant identifier and the amount due via the network interface; and if automatic payment is not enabled for the client device, then, based at least in part on automatic payment not being enabled for the client device, (i) requesting an acceptance of the bill via the user interface and (ii) in response to obtaining the acceptance of the bill via the user interface, sending to the transaction server the merchant identifier, the amount due, and details of a payment instrument via the network interface.

In a fourth aspect, an article of manufacture may include a non-transitory computer-readable medium, having stored thereon program instructions, that upon execution by a computing device, cause the computing device to perform the operations of any of the first, second, or third aspects.

In a fifth aspect, a computing device may include at least one processor, and a memory having stored thereon program instructions executable by the at least one processor to perform the operations of any of the first, second, or third aspects.

In a sixth aspect, a system may include various means for carrying out the operations of any of the first, second, or third aspects.

In embodiments of the disclosure in which a computer software product is used, the product may be non-transitory and store instructions on physical media such as a DVD, or a solid state drive, or a hard drive. Alternatively, the product may be transitory and in the form of instructions provided over a connection such as a network connection which is linked to a network such as the Internet.

These aspects, as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a schematic representation of a system for paying bills, in accordance with example embodiments.

FIG. 2 illustrates an example encoding of a bill, in accordance with example embodiments.

FIG. 3 is a simplified block diagram of an example client device, in accordance with example embodiments.

FIG. 4 is a simplified block diagram of an example transaction server, in accordance with example embodiments.

FIG. 5 is a flow chart, in accordance with example embodiments.

FIG. 6A is another flow chart, in accordance with example embodiments.

FIG. 6B is yet another flow chart, in accordance with example embodiments.

FIG. 7 is yet another flow chart, in accordance with example embodiments.

FIG. 8 is yet another flow chart, in accordance with example embodiments.

FIG. 9 is yet another flow chart in accordance with example embodiments.

### DETAILED DESCRIPTION

### I. Introduction

This description describes, among other things, several example embodiments including, but not limited to, example embodiments pertaining to paying a bill at a merchant establishment.

By way of example, a client device and a merchant may use a transaction server to facilitate payment of a bill. The client device may include a scanner, a network interface, and a user interface. Upon completion of a transaction at a merchant establishment, the merchant may provide an encoding of a bill. The client device can then scan the encoding of the bill using the scanner. In response to scanning the encoding of the bill, the client device can decode the encoding of the bill to determine contents of the bill. For instance, the contents of the bill may include a merchant identifier and an amount due, and the client device can decode the encoding of the bill to determine the merchant identifier and the amount due.

The client device can then determine whether automatic payment is enabled for the client device, and proceed accordingly. In particular, if automatic payment is enabled for the client device, then, based at least in part on automatic payment being enabled for the client device, the client device can send to the transaction server the merchant identifier, the amount due, and details of a preselected payment instrument via the network interface. Whereas, if automatic payment is not enabled for the client device, then, based at least in part on automatic payment not being enabled for the client device, the client device can request an acceptance of the bill via the user interface. And in response to obtaining the acceptance of the bill via the user interface, the client device can send to the transaction server the merchant identifier, the amount due, and details of a payment instrument via the network interface. Advantageously, when automatic payment is enabled, a user of the client device can automatically pay a bill by simply scanning the encoding of the bill. With automatic payment enabled, the user might not need to provide any other input after scanning the encoding of the bill, thereby reducing the tedium of bill payment and providing a more efficient method of bill payment.

In some embodiments, the client device may prompt the user to enable automatic payment after completion of a first successful payment of a merchant bill using the client device. For instance, as discussed above, after obtaining an acceptance of a bill via the user interface of the client device, the client device can send to the transaction server the merchant identifier, the amount due, and details of a payment instrument. The transaction server, in turn, may attempt to pay the bill using the details of the payment instrument. For instance, the transaction server may send the particulars of the financial transaction to a payment processor for processing. If the payment is successful via the payment instrument, the transaction server may notify the client device that the payment was successful. In response to receiving the notification that payment was successful, the client device can then prompt the user of the client device to enable automatic payment on the client device. For example, the client device may prompt the user of the client device to enable automatic payment on the client device and set the payment instrument as a designated payment instrument for automatic payment. If the user opts to enable automatic payment on the client device, the client device can enable automatic payment on the client device, and the user can then subsequently pay bills at merchants by simply scanning encodings of bills using the scanner of the client device.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” with a described list of at least two terms is to indicate any of the listed terms or any combination of the listed terms.

The use of ordinal numbers such as “first,” “second,” “third,” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### II. Example Architecture

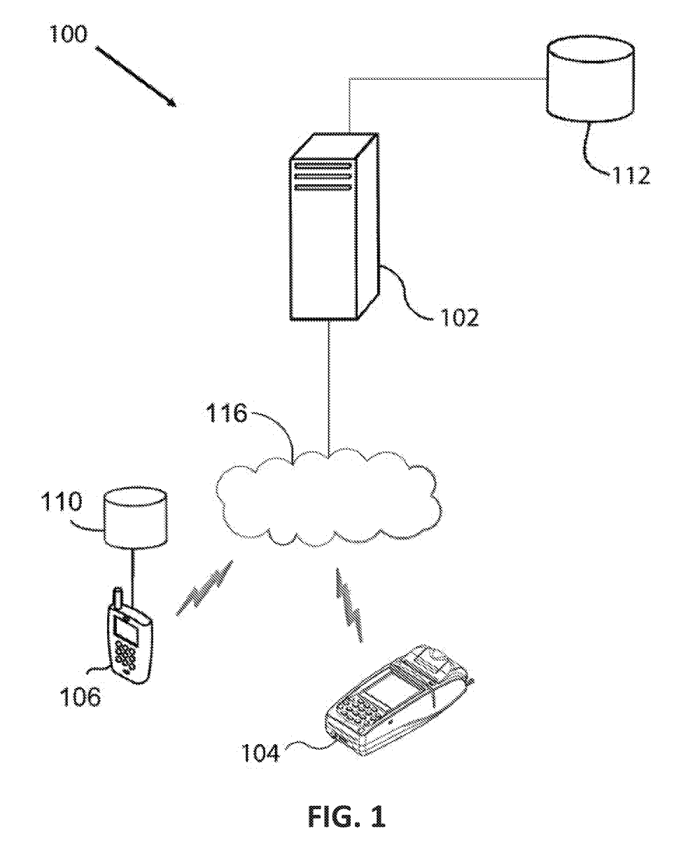

FIG. 1 depicts a schematic representation of an example system 100 in accordance with example embodiments described herein. The system 100 includes a transaction server 102, a POS device 104, one or more client devices 106, one or more user profiles 110, a merchant database 112, and a communications network 116.

The one or more client devices 106 can take the form of a mobile wireless computing device. For example, any of the one or more client devices 106 can take the form of a smartphone handset provisioned with software for scanning encodings of bills (e.g., QR codes), a web browser, and a wireless connection to the Internet. A mobile wireless computing device can be referred to as a “mobile smartphone handset” or, more simply, a “mobile smartphone” or “smartphone.” One example of a mobile smartphone is a personal digital assistant or a cellular telephone. Another example of a mobile smartphone is an iPhone®, such as the iPhone6, or an iPad® sold by Apple Inc., of Cupertino, Calif., United States.

To help illustrate features of the present disclosure, portions of this document will focus on mobile smartphones by way of example. Those of ordinary skill in the art will readily appreciate, however, that the disclosed principles can be applied as well using other types of computing devices, with variations where appropriate.

The transaction server 102, the POS device 104, and the one or more client devices 106 can communicate with each other using the communications network 116. The communications network 116 can comprise a wide-area network, such as the Internet.

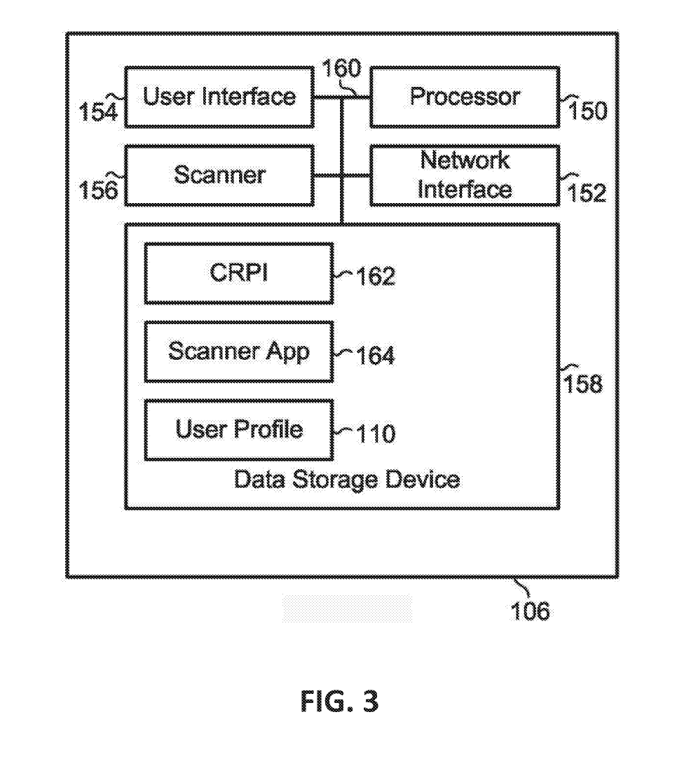

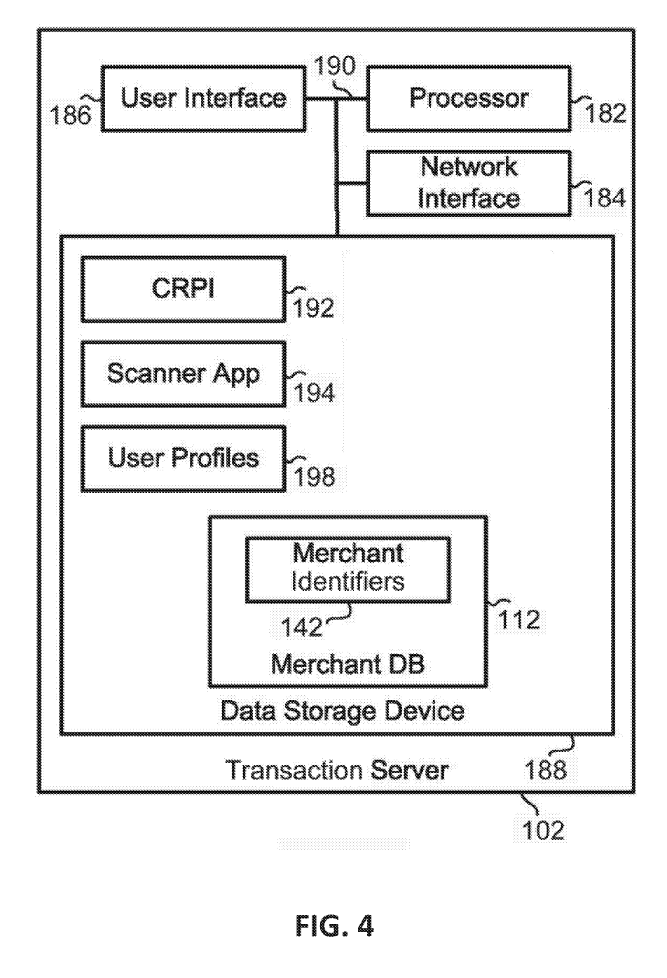

Communication between the transaction server 102 and one of the client devices can be facilitated by using a server-hosted program (not shown), such as a scanner application program (a “scanner app”) that is installed and executed on one of the client devices or accessed using a web browser on one of the client devices. In another respect, communication between the transaction server 102 and one of the client devices can occur using a pair of network interfaces (such as the network interface 154 shown in FIG. 3 and the network interface 186 shown in FIG. 4).

In one example, a user can download a copy of the scanner app from a download repository (for example, data storage device 188 in FIG. 4) and install the scanner app on a client device. On, during, or after installation, the scanner app may create a user profile 110 on the client device and may prompt the user to manually provide personal attributes such as the user's first name, the user's last name, an e-mail address, a physical address, and particulars of one or more payment instruments (such as credit cards, debit cards, electronic wallets, and the like). The user profile may store details regarding whether automatic payment is enabled. Further, if automatic payment is enabled, the user profile may store an indicate of the selected payment instrument for automatic payment.

In accordance with at least some example embodiments, the user profile 110 (for example, the data in the user profile 110) is stored locally on the client device and is not passed to the transaction server 102. Alternatively, the user profile 110 can be replicated and stored on the transaction server 102. With such an arrangement, a scanner app on the client device may synchronize changes to the user profile 110 with a copy of the user profile that is stored on the transaction server, either as the changes occur, periodically, or explicitly under user command. The copy of the user profile on the transaction server can then be imported to a different client device when, for example, a user changes client devices or in the event the user loses or damages their client device. Further, in some embodiments, in order to improve security of the system 100, transmission of data from the user profile 110 (e.g., details of the user's identity or details of a payment instrument) to the transaction server 102 by the scanner app may be encrypted.

In another example, the scanner app may be a web application that the user may access using a web browser rather than by downloading a copy of the scanner app.

A merchant can set up the merchant's business for QR-based bill payment. The transaction server 102 can assign a unique merchant identification code to each merchant business configured in this manner and the merchant identification code is stored in the merchant's profile in the merchant database 112. Additionally or alternatively, each merchant identification code can be provided to and stored with a QR source that serves QR codes to the POS device 104. For the sake of brevity, a merchant identification code can be referred to as a “merchant identifier.”

In this description the terms “user” and “customer” are used interchangeably depending on the context. For example a user of the scanner app on one of the client devices can also be a customer of the merchant.

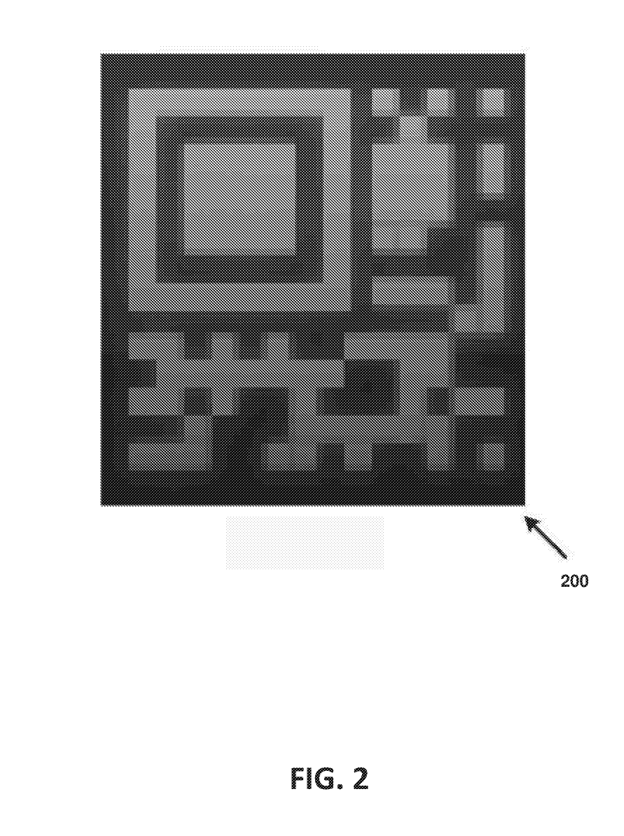

FIG. 2 illustrates an example encoding of a bill in the form of a QR code 200. As shown in FIG. 2, QR code 200 may be a two-dimensional QR that encodes details of a bill. The details of the bill may include a merchant identifier and an amount due. The details of the bill may also include other information, such as a bill identifier that identifies the bill, a time/date of the bill, a location identifier that identifies the merchant, and/or an itemization of the bill. One of ordinary skill will appreciate that other types of encodings can also be used to scan bills, so long as the encodings are scannable by the scanners of the client devices.

In some examples, merchants may register bills with the transaction server 102. For instance, after generating a bill, the POS device 104 may send to the transaction server 102 details of the bill, including the merchant identifier and the amount due, for instance.

Transaction server 102, in turn, may maintain a bills database (not shown). When the transaction server 102 receives payment particulars from one of the client devices and processes payments, the transaction server 102 can update the bills database to indicate which bills are paid or unpaid.

Next, FIG. 3 is a block diagram depicting an example embodiment of one of the client devices 106. In line with the discussion above, client device 106 may take any of a variety of forms, including, for example, a mobile phone, a tablet device, a wearable client device, or some other type of client device. As shown in FIG. 3, client device 106 may include a processor 150, a network interface 152, a user interface 154, a scanner 156, and a data storage device 158, all of which may be coupled together via a system bus, network, or other connection mechanism 160.

The processor 150 can include a general-purpose processor (e.g., a microprocessor) or a special-purpose processor (e.g., a digital signal processor an application specific integrated circuit).

The network interface 152 may include a wired or wireless communication interface. For purposes of this description, any data described as being sent or transmitted by client device 106 can be data sent by network interface 152 over a communication network. For instance, client device 106 can use network interface 152 to transmit data to and receive data from communications network 116 of FIG. 1.

The user interface 154 may facilitate interaction with a user. As such, the user interface 154 may take the form of a graphical user interface (GUI) and may include output components such as a speaker and a display as well as input components such as a keypad, touch-sensitive screen, or microphone.

A user may use the scanner 156 to scan (for example, capture) encodings of bills such as QR codes.

Data storage device 158 may include volatile or non-volatile storage components and may be integrated in whole or in part with processor 150. Data storage device 158 may take the form of a non-transitory computer-readable medium and may include computer-readable program instructions (“CRPI”) 162, that when executed by processor 150, cause client device 106 to perform one or more of the operations described herein. Any software program instructions discussed in this description or shown in the drawings can be referred to as CRPI, or more simply, program instructions. In one example, the CRPI 162 may include instructions for executing a scanner app 164. Further, data storage device 158 may also store user profile 110.

Next, FIG. 4 is a block diagram depicting an example embodiment of transaction server 102. As shown in FIG. 4, transaction server 102 may include a processor 182, a network interface 184, a user interface 186, and a data storage device 188, all of which may be coupled together via a system bus, network, or other connection mechanism 190.

The processor 182 can include a general-purpose processor (e.g., a microprocessor) or a special-purpose processor (e.g., a digital signal processor an application specific integrated circuit).

The network interface 184 may include a wired or wireless communication interface. For purposes of this description, any data described as being sent or transmitted by transaction server 102 can be data sent by network interface 184 over a communication network. For instance, transaction server 102 can use network interface 184 to transmit data to and receive data from communications network 116 of FIG. 1.

Data storage device 188 may include volatile or non-volatile storage components and may be integrated in whole or in part with processor 182. Data storage device 188 may take the form of a non-transitory computer-readable medium and may include CRPI 192, that when executed by processor 182, cause transaction server 102 to perform one or more of the operations described herein. In one example, the CRPI 192 may include instructions for executing a scanner app 194. Further, data storage device 188 may also store a plurality of user profiles 198. In line with the discussion above, in some examples, the user profiles may indicate whether automatic payment is enabled. And if automatic payment is enabled, the user profiles may indicate the particulars of the payment instrument selected for automatic payment. Still further, data storage device 188 may also include merchant database 112 including merchant profiles 142. The merchant profiles 142 may store merchant identifiers and details regarding merchants, such as name, billing address, banking or electronic funds account, etc.

### III. Example Operation—Generating Encodings of Bills

The system 100 can be used to receive and to pay a bill at a merchant establishment by use of the client device 106. The system 100 is applicable to payment of any bill that is generated by a POS device associated with any type of merchant. The merchant may have registered with and have been assigned a merchant identifier 142 by the transaction server 102. The merchant identifier 142 may be stored on any of the transaction server 102 and the POS device 104.

Upon completion of a transaction at a merchant establishment, for example the purchase by a user of goods or a service, the merchant may produce a bill for payment, by providing inputs to the POS device 104. The provided inputs may represent, for example, billing information that includes one or more of a merchant identifier that identifies the merchant, a bill identifier that identifies the bill, a location identifier that identifies the merchant establishment (e.g., a physical address or a store number), an itemization of the bill, sales or value-added tax, and a total amount due. In some examples, instead of the merchant providing input representing the bill identifier, the location identifier, the tax added to the bill, or the total amount due, that information may be stored in the POS device 104, or otherwise accessible to the POS device 104 and added to the bill without reference to input provided by the merchant to the POS device 104. Generally, any identifier mentioned above may include any numeric, alphanumeric, or alphabetic data that identifies a corresponding object (e.g., is recognizable by the transaction server 102, the client device 106, or the POS device 104 as identifying the corresponding object).

After producing the bill, the POS device 104 can provide an encoding of the bill, such as a QR code. The encoding of the bill may encode a merchant identifier and an amount due. The encoding of the bill may also include a bill identifier. The encoding of the bill can be generated by the POS device 104 or may be served to the POS device 104 by an external source of QR codes.

The bill and the encoding of the bill can be provided, individually or in combination, to the customer. For example, the POS device 104 may print a hardcopy of the bill that contains a QR code, or may print a QR code separately from the bill. Alternatively, the POS device or another device may present an encoding of the bill to the customer on an electronic display instead of in hardcopy form.

### IV. Example Operation—Activating Automatic Payment

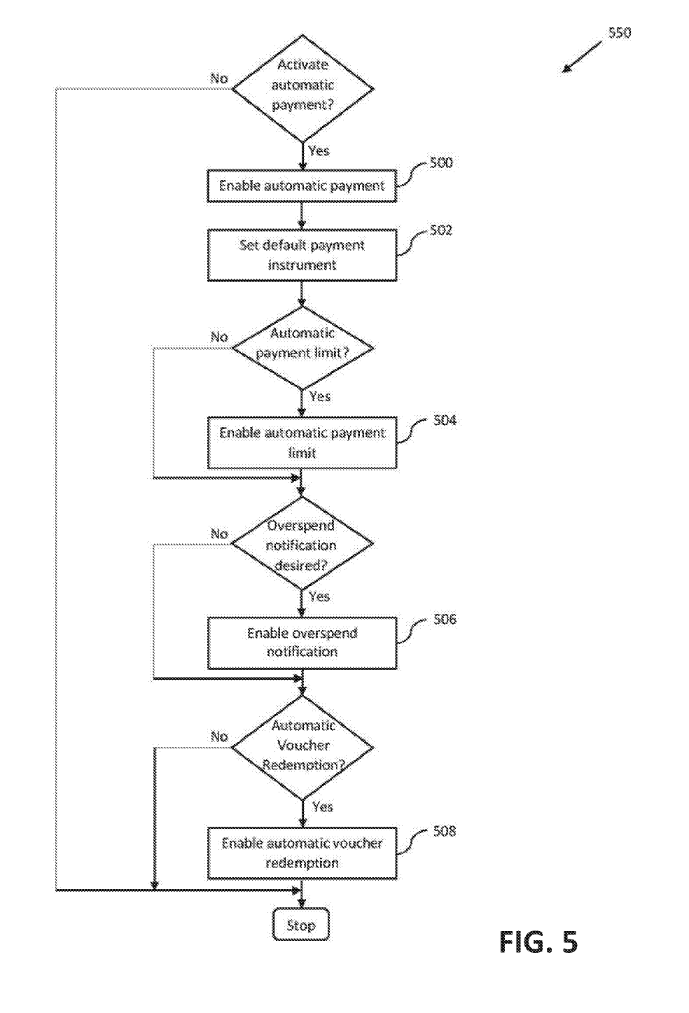

The user may, at any time, elect to activate automatic payment of merchant bills via the client device 106. FIG. 5 is a flow chart depicting a set of functions 550 that can be performed to activate and to configure automatic payment of merchant bills via the client device 106. The set of functions 550 are shown within blocks 500 through 508. A description of those blocks now follows.

At block 500, the user may enable automatic payment functionality of the scanner app 164 if desired. The scanner app may display an automatic payment activation icon or radio button on the user interface 154 of the client device 106 that the user may select in order to enable this function. In one embodiment, once enabled, automatic payment may remain enabled until the client device is powered down. In another embodiment, once enabled, automatic payment may remain enabled until the scanner app is stopped from running. The user may also elect to disable automatic payment of merchant bills at any time.

Next, at block 502, the user may select a default payment instrument to be used when making automatic payments. In one example, the default payment instrument may be one of the payment instruments registered in the user's profile 110. Alternatively, the default payment instrument may be a new payment instrument, the particulars of which may be added to the user profile 110.

Further, in some examples, after automatic payment is enabled and the default payment instrument is selected, the scanner app may transmit to the transaction server the details of the default payment instrument together with a flag indicating that automatic payment is enabled. The transaction server may then store the automatic payment state (i.e., enabled or disabled) as well as the details of the default payment instrument for use in automatic payment transactions.

Next, at block 504, the user may, if desired, set a threshold limit for automatic payments. In one example, automatic payment may only be permitted in respect of merchant bills in which the amount owing does not exceed the threshold limit.

Next, at block 506, the user may, if desired, configure the scanner app 164 to display a notification on the user interface 154 of the client device 106 when the user is attempting to pay a merchant bill that exceeds the threshold limit. In one example, the notification may include icons that allow the user to cancel payment of the merchant bill or to allow payment of the bill to proceed. Alternatively, in another example, the scanner app 164 may require the use of a password (or PIN) to proceed with payment of a merchant bill that exceeds the threshold limit.

Next, at block 508, the user may, if desired, configure the scanner app 164 to automatically redeem any qualifying vouchers that the user may have received from a merchant whose bill the user is attempting to pay automatically. The scanner app 164 may store vouchers that the user has received from merchants. Each voucher may include a merchant identifier. When automatic voucher redemption is enabled, the scanner may search the stored vouchers for any qualifying vouchers corresponding to the merchant that issued the bill. Upon identifying a qualifying voucher, the monetary value of the qualifying voucher, or vouchers, may be applied to reduce the amount due on the merchant's bill. Alternatively, if automatic voucher redemption is not enabled, the scanner app 164 may require the user to explicitly approve redemption of a voucher.

### V. Example Operation—Automatic Payment

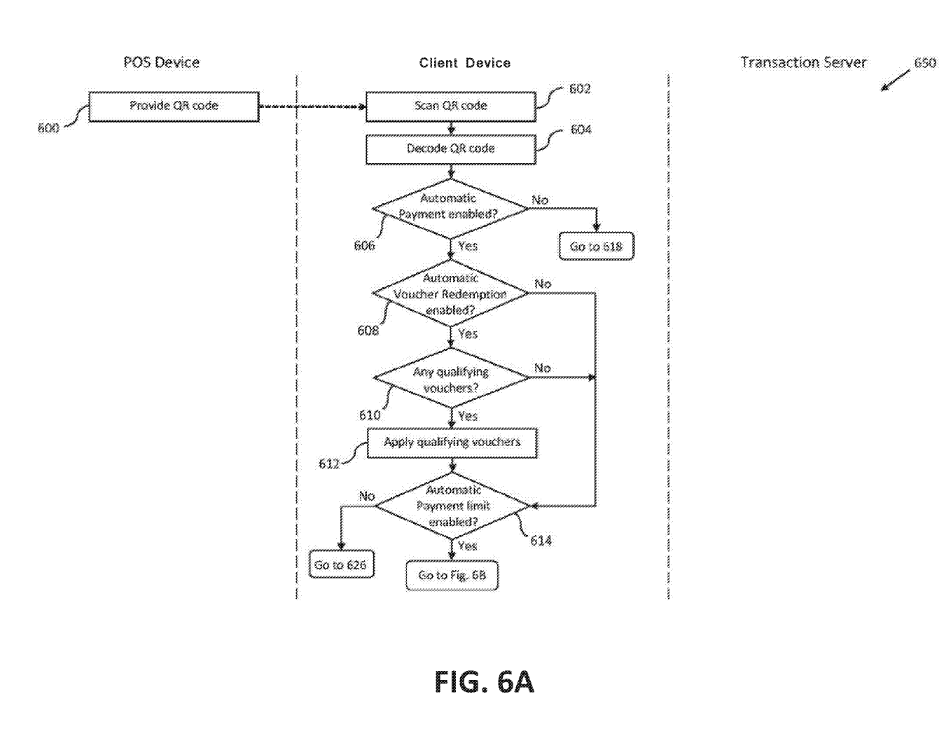

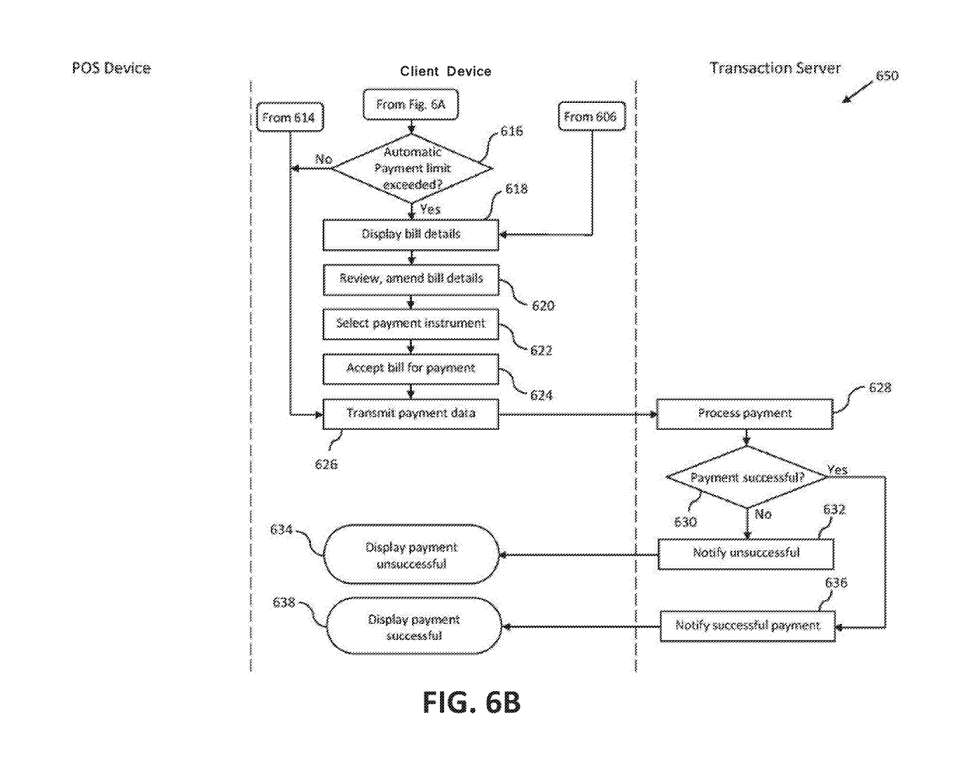

FIG. 6A and FIG. 6B (collectively, FIGS. 6A-6B) illustrate a flow chart depicting a set of functions 650 that can be carried out in accordance with an example embodiment. The set of functions 650 can be performed to pay the bill issued by the merchant at the merchant establishment. The set of functions 650 is shown within blocks 600 through 638. A description of those blocks now follows.

At block 600, the POS device 104 can provide a payment QR code that encodes the merchant identifier, and the amount due, and optionally encodes the bill identifier and all the details contained in the bill. The payment QR code may be generated by the POS device 104 or may be served to the POS device by an external source of QR codes (not shown).

In line with the discussion above, the bill and the payment QR code can be provided, individually or in combination, to the customer. For example, the POS device 104 may print a hardcopy of the bill that contains the payment QR code, or may print the QR code separately from a hardcopy of the bill. Alternatively, the payment QR code may be provided on an electronic display.

The user may, at block 602, use the scanner app 164 and the scanner 156 to scan the payment QR code. At block 604, the scanner app 164 may decode the scanned payment QR code to recover the encoded data that it contains, such as the merchant identifier, the bill identifier, and the bill details.

Next, at block 606, the scanner app 164 may determine whether the user of the client device 106 has enabled automatic payment of merchant bills. If automatic payment has not been enabled, the scanner app 164 may, at block 618, display the bill details on the user interface 154 of the client device 106. Next, at block 620, the user may review the bill details and amend the displayed data, if necessary, via the user interface 154. After reviewing and amending the displayed bill data, the user may select, via the user interface 154, a payment instrument to pay the bill, at block 622. Next, at block 624, the user may accept the bill for payment via the user interface 154. The scanner app 164 may then transmit to the transaction server 102, at block 626, payment data including, for example, the merchant identifier, the bill identifier, the amount due, and the details of the payment instrument to be used for payment (for example, a credit or debit card number, a cardholder's name, a card expiry date, a CVC, or a PIN, as stored in the user profile 110).

At block 606, if automatic payment has been enabled, scanner app 164 may, at block 608, determine whether the user of the client device has enabled automatic voucher redemption. If automatic voucher redemption has not been enabled, the scanner app 164 may, at block 614, determine whether the user of the client device has set an automatic payment limit. If an automatic payment limit has not been set, the scanner app may then transmit the payment data to the transaction server 102 as described above with reference to block 626.

If the user has enabled automatic voucher redemption, the scanner app 164 may, at block 610, determine whether the user possesses any qualifying vouchers that can be applied towards payment of the merchant's bill. If the user does not possess any qualifying vouchers, the full amount of the merchant's bill remains due. If an automatic payment limit has not been set, the scanner app 164 may then transmit the payment data to the transaction server 102 as described above with reference to block 626. Alternatively, if the user has one or more qualifying vouchers, the scanner app may, at block 612, deduct the value of the qualifying vouchers from the amount due on the merchant's bill. If an automatic payment limit has not been set, the scanner app 164 may then transmit the payment data, including the reduced balance due on the merchant's bill, to the transaction server 102 as described above with respect to block 626.

If the user has set an automatic payment limit, the scanner app 164 may, at block 616, determine whether the amount due on the merchant's bill or, alternatively, the reduced balance due on the merchant's bill after deduction of the value of any qualifying vouchers exceeds the user's automatic payment limit. If the amount due does not exceed the automatic payment limit, the scanner app 164 may then transmit the payment data to the transaction server 102 as described above with reference to block 626. If, on the other hand, the amount due or the reduced amount due exceeds the automatic payment limit, the scanner app 164 may display the bill details on the user interface 154 of the client device at block 618. The user may review and, if necessary, amend the bill details at block 620 via the user interface 154 and may explicitly accept the bill for payment using the default payment instrument via the user interface 154 at block 624.

Once the payment data has been received at the transaction server 102, the particulars of the financial transaction (for example, the balance due, merchant details, and payment details) may be sent, at block 628, to a payment processor (not shown) for processing. Alternatively, instead of the transaction server 102 sending the particulars of the financial transaction to a payment processor for processing, the transaction server 102 can process the payment itself.

At block 630, the transaction server 102 can determine whether the payment was successful or not. If the payment was successful, the transaction server 102 may notify the scanner app 164, at block 636, that payment was successful and that the merchant's bill has been paid. Then, at block 638, the client device may display a notification that payment was successful. For instance, the client device may display the notification that payment was successful via the user interface 154. If, on the other hand, the payment was unsuccessful, the transaction server 102 may notify the scanner app 164, at block 632, that payment was unsuccessful and the user interface 154 may refresh, at block 634, to request the user to select a different payment instrument and to re-attempt payment.

As discussed above, in some examples, the scanner app may prompt the user to enable automatic payment of merchant bills after completion of a first successful payment of a merchant bill through use of the client device 106. In particular, if automatic payment is not enabled, the scanner app may prompt the user via the user interface 154 to enable automatic payment after the user successfully completes a transaction by explicitly accepting the bill for payment (at block 624). As an example, when automatic payment is not enabled, in response to receiving the notification at block 636 that payment was successful, the scanner app may display, via the user interface 154, a notification that the bill was successful and display a notification prompting the user to enable automatic payment. The notification may include an icon that the user can select to configure the scanner app for automatic payment.

In one instance, the notification may prompt the user to enable automatic payment and designate the payment instrument used in the previous transaction as the designated payment instrument for automatic payment. In another instance, the notification may prompt the user to enable automatic payment with a particular automatic payment limit. For example, the scanner app may determine a device-specific automatic payment limit based on a payment history on the client device. The notification may ask whether the user would like to enable automatic payment limit and configure the device-specific payment limit as the automatic payment limit. If the user accepts the prompt(s) (e.g., selects “Yes” or checks a box), the scanner app may enable automatic payment and configure the device-specific payment limit as the automatic payment limit.

In one example, the scanner app may store a payment history that identifies one or more completed transactions and, for each transaction, the amount paid and details of the payment instrument used. With such a payment history, the scanner app can determine a suggested automatic payment limit based on the payment history. After a user completes a transaction using a particular payment instrument, the scanner app may determine an average amount paid via the particular payment instrument, and prompt the user to enable automatic payment limit with the particular payment instrument designated as the payment instrument for automatic payment and the average amount paid set as the automatic payment limit. Similarly, the scanner app may determine a percentile (e.g., 75^{th}, 85^{th}, etc.) or the maximum amount paid via the particular payment instrument, and prompt the user to configure the percentile or maximum amount as the automatic payment limit.

Additionally, in some examples, if a user opts to activate an automatic payment limit, the scanner app may request a designation of an override password. The override password is a password that the user is required to input to authorize an automatic payment that exceeds the automatic payment limit. In response to obtaining a password via the user interface, the scanner app may configure the password as the override password.

Notably, the features of determining whether automatic payment is enabled and, if so, automatically sending to the transaction server the merchant identifier, the amount due, and details of a preselected payment instrument are an improvement to existing bill payment technology. Traditionally, a party must review a bill on the client device, select a payment instrument, and then explicitly accept and authorize payment of the bill. Due to this limitation, transactions are lengthy and tedious. Computer implementation, however, enables a party to automatically pay a bill by simply scanning an encoding of the bill. By removing the need to review a bill, select a payment instrument, and authorize payment, transactions can be completed more efficiently. Consequently, the disclosure herein is a technological improvement to bill payment.

In the example discussed above, with automatic payment enabled, the scanner app 164 may transmit details of the payment instrument to the transaction server 102 at block 626 together with other payment data such as the merchant identifier, the bill identifier, and the amount due. Alternatively, in another embodiment, with automatic payment enabled, the scanner app 164 might not include the details of the payment instrument in the payment data transmitted to the transaction server at block 626.

For instance, if the scanner app 164 sends data indicative of the automatic payment state (i.e., enabled or disabled) to the transaction server 102 (e.g., after automatic payment is enabled by the user) such that the transaction server is aware of the automatic payment state, the payment data may differ depending on whether automatic payment is enabled or disabled. If, for example, automatic payment is not enabled, the user may select, via the user interface 154, a payment instrument to pay the bill, at block 622. And the scanner app 164 then includes the details of the selected payment instrument as part of the payment data that is transmitted to the transaction server 102.

If, on the other hand, automatic payment is enabled, the scanner app 164 may transmit details of the default payment instrument to the transaction server 102 at the time that automatic payment is enabled, together with a flag indicating that automatic payment is enabled. The transaction server 102 may then store the automatic payment state (i.e., enabled or disabled) as well as details of the default payment instrument for use in automatic payment transactions. Accordingly, the scanner app 164 need not include details of the default payment instrument in the payment data transmitted at block 626. Rather, when the transaction server 102 receives payment data from the scanner app 164, the transaction server 164 can determine identifying information of the scanner app 164 (e.g., a device ID of the client device from which the payment data was sent), and correlate the identifying information to a user profile. The transaction server can then retrieve the details of the default payment instrument from the user profile, and use the retrieved details to process the transaction. Alternatively, the payment data may include a user ID or other information that the transaction server 102 can link to a user profile. And the transaction server 102 can use the user ID or other information to correlate the payment data to a user profile.

This arrangement provides improved security, since no transmission of payment details over the air are required at the time of automatic payment transactions. Consequently, there is less risk of unauthorized interception of payment instrument details. Furthermore, this arrangement provides a reduction in the transmitted traffic for such automatic payment transactions.

### VI. Additional Example Operations

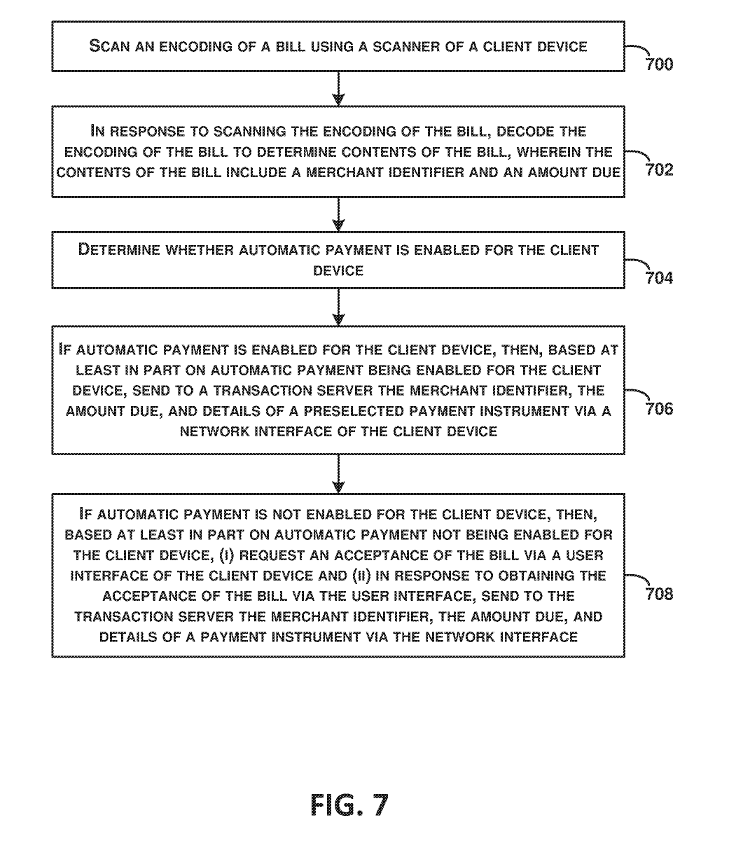

FIG. 7 depicts a flow chart showing a set of operations that can, for example, be carried out using a client device, such as the client device 106. Several of the operations described in connection with FIG. 7 parallel operations described in connection with FIGS. 5, 6A, and 6B. As such, variations of the operations described in connection with FIGS. 5, 6A, and 6B are likewise applicable to the operations described in connection with FIG. 7. However, for the sake of brevity, these variations are not repeated.

Initially, block 700 includes scanning an encoding of a bill using a scanner of a client device.

Next, block 702 includes, in response to scanning the encoding of the bill, decoding the encoding of the bill to determine contents of the bill. The contents of the bill include a merchant identifier and an amount due. The contents of the bill can also include a bill identifier.

Next, block 704 includes determining whether automatic payment is enabled for the client device. In some embodiments, determining whether automatic payment is enabled for the client device can include determining whether a user of the client device has configured the client device for automatic payment of bills from merchants.

Next, block 706 includes, if automatic payment is enabled for the client device, then, based at least in part on automatic payment being enabled for the client device, sending to a transaction server the merchant identifier, the amount due, and details of a preselected payment instrument via a network interface of the client device. In an embodiment in which the contents of the bill also include a bill identifier, the client device can, at block 706, also send the bill identifier to the transaction server via the network interface.

Next, block 708 includes, if automatic payment is not enabled for the client device, then, based at least in part on automatic payment not being enabled for the client device, (i) requesting an acceptance of the bill via a user interface of the client device and (ii) in response to obtaining the acceptance of the bill via the user interface, sending to the transaction server the merchant identifier, the amount due, and details of a payment instrument via the network interface. In some embodiments, requesting the acceptance of the bill includes displaying at least the amount due on the client device. In some embodiments, requesting the acceptance of the bill includes requesting a selection of a payment instrument, and obtaining the acceptance of the bill includes receiving a selection of the payment instrument via the user interface. In an embodiment in which the contents of the bill also include a bill identifier, the client device can, at block 708, also send the bill identifier to the transaction server via the network interface.

In some embodiments, if automatic payment is enabled for the client device, then the client device may determine whether an automatic payment limit is set for the client device. If the automatic payment limit is set, then the client device may determine whether the amount due exceeds the automatic payment limit. If the amount due does not exceed the automatic payment limit, the client device sends the merchant identifier, the amount due, and the details of the preselected payment instrument to the transaction server via the network interface at least partially in response to a determination that the amount due does not exceed the automatic payment limit. Whereas, if the amount due exceeds the automatic payment limit, the client device requests the acceptance of the bill via the user interface at least partially in response to a determination that the amount due exceeds the automatic payment limit. On the other hand, if the automatic payment limit is not set, the client device sends the merchant identifier, the amount due, and the details of the preselected payment instrument to the transaction server via the network interface at least partially in response to a determination that the automatic payment limit is not set.

In some embodiments, if automatic payment is enabled for the client device, then the client device may determine whether an automatic payment limit is set for the client device. If the automatic payment limit is set, then the client device may determine whether the amount due exceeds the automatic payment limit. If the amount due does not exceed the automatic payment limit, the client device sends the merchant identifier, the amount due, and the details of the preselected payment instrument to the transaction server via the network interface at least partially in response to a determination that the amount due does not exceed the automatic payment limit. Whereas, if the amount due exceeds the automatic payment limit, the client device requests an override password and sends the merchant identifier, the amount due, and the details of the preselected payment instrument to the transaction server via the network interface at least partially in response to a verification of a received override password. On the other hand, if the automatic payment limit is not set, the client device sends the merchant identifier, the amount due, and the details of the preselected payment instrument to the transaction server via the network interface at least partially in response to a determination that the automatic payment limit is not set.

In some embodiments, if automatic payment is enabled for the client device, then the client device may determine whether an automatic payment limit is set for the client device. If the automatic payment limit is set, then the client device may determine whether the amount due exceeds the automatic payment limit. If the amount due does not exceed the automatic payment limit, the client device sends the merchant identifier, the amount due, and the details of the preselected payment instrument to the transaction server via the network interface at least partially in response to a determination that the amount due does not exceed the automatic payment limit. Whereas, if the amount due exceeds the automatic payment limit, the client device prompts a user to confirm the payment request and sends the merchant identifier, the amount due, and the details of the preselected payment instrument to the transaction server via the network interface at least partially in response to receiving a confirmation of the payment request. On the other hand, if the automatic payment limit is not set, the client device sends the merchant identifier, the amount due, and the details of the preselected payment instrument to the transaction server via the network interface at least partially in response to a determination that the automatic payment limit is not set.

In some embodiments, if automatic payment is enabled for the client device, then the client device may determine whether automatic voucher redemption is enabled for the client device. If automatic voucher redemption is enabled for the client device, then the client device may determine whether there is a qualifying voucher stored on the client device. The qualifying voucher may be a voucher that can be applied toward the bill. If there is a qualifying voucher stored on the client device, the client device determines a reduced balance due by applying the qualifying voucher to the amount due and sends the merchant identifier, the amount due, the reduced balance due, a voucher identifier of the qualifying voucher, and the details of the preselected payment instrument to the transaction sever via the network interface at least partially in response to a determination that there is a qualifying voucher stored on the client device. Whereas, if there is not a qualifying voucher stored on the client device, the client device sends the merchant identifier, the amount due, and the details of the preselected payment instrument to the transaction server via the network interface at least partially in response to a determination that there is not a qualifying voucher stored on the client device. On the other hand, if automatic voucher redemption is not enabled, the client device sends the merchant identifier, the amount due, and the details of the preselected payment instrument to the transaction server via the network interface at least partially in response to a determination that automatic voucher redemption is not enabled.

In some embodiments, after obtaining the acceptance of the bill and sending to the transaction server the merchant identifier, the amount due, and the details of the payment instrument, the client device can receive from the transaction server via the network interface a notification that the bill is paid. Further, in response to receiving the notification that the bill is paid, the client device prompts a user of the client device to enable automatic payment for the client device.

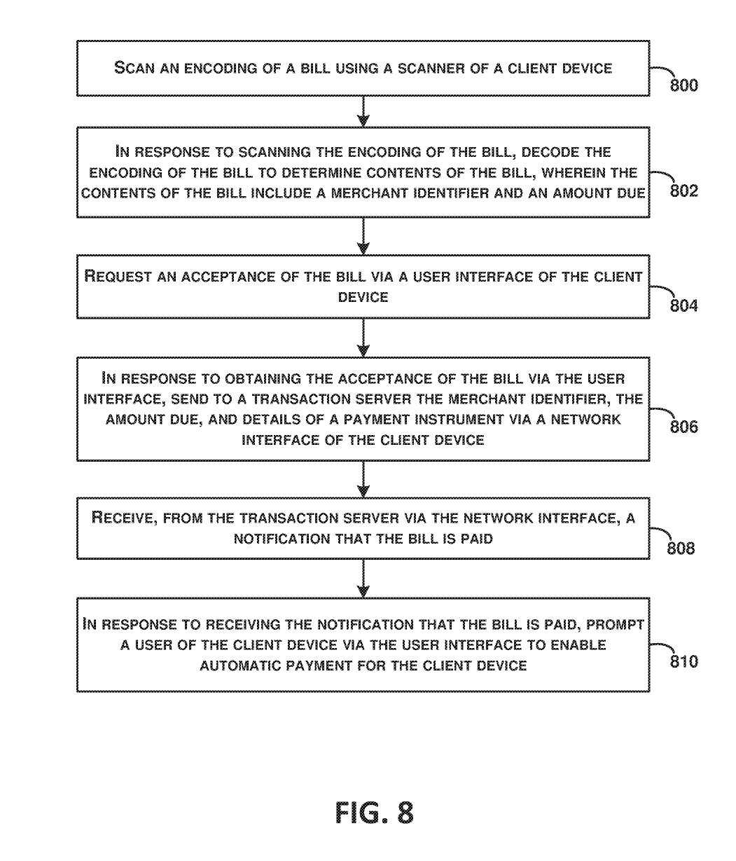

Next, FIG. 8 depicts a flow chart showing a set of operations that can, for example, be carried out using a client device, such as the client device 106. Several of the operations described in connection with FIG. 8 parallel operations described in connection with FIGS. 5, 6A, and 6B. As such, variations of the operations described in connection with FIGS. 5, 6A, and 6B are likewise applicable to the operations described in connection with FIG. 7. However, for the sake of brevity, these variations are not repeated.

Initially, block 800 includes scanning an encoding of a bill using a scanner of a client device.

Next, block 802 includes, in response to scanning the encoding of the bill, decoding the encoding of the bill to determine contents of the bill. The contents of the bill include a merchant identifier and an amount due. The contents of the bill can also include a bill identifier.

Next, block 804 includes requesting an acceptance of the bill via a user interface of the client device.

Next, block 806 includes, in response to obtaining the acceptance of the bill via the user interface, sending to a transaction server the merchant identifier, the amount due, and details of a payment instrument via a network interface of the client device.

Next, block 808 includes receiving, from the transaction server via the network interface, a notification that the bill is paid.

Next, block 810 includes, in response to receiving the notification that the bill is paid, prompting a user of the client device via the user interface to enable automatic payment for the client device. Prompting the user of the client device via the user interface to enable automatic payment can including prompting the user of the client device via the user interface to: enable automatic payment for the client device and select the payment instrument as a designated payment instrument for automatic payment.

Additionally, in some embodiments, in response to receiving the notification that the bill is paid, the client device also determines a device-specific automatic payment limit based on a payment history of the client device, and the client device prompts the user of the client device via the user interface to: enable automatic payment for the client device and set the device-specific payment limit as the automatic payment limit. The payment history of the client device can include a payment history of the client device via the payment instrument. Further, the client device can prompt the user of the client device via the user interface to: enable automatic payment for the client device, select the payment instrument as a designated payment instrument, and set the device-specific payment limit as the automatic payment limit.

In some embodiments, the client device receives via the user interface a request to enable automatic payment, and enables automatic payment for the client device.

In some embodiments, in response to receiving via the user interface a request to enable automatic payment, the client device requests a selection of a default payment instrument via the user interface. And in response to obtaining the selection of the default payment instrument, the client device enables automatic payment on the client device via the selected default payment instrument.

In some embodiments, the client device receives via the user interface a payment limit for automatic payment on the client device and, in response to receiving the payment limit, sets the payment limit as the automatic payment limit. Further, in response to receiving the payment limit, the client device requests a designation of an override password via the user interface. And in response to obtaining a password via the user interface, the client device sets the password as the override password.

In some embodiments, the client device receives via the user interface a request to activate automatic voucher redemption and, in response to receiving the request, the client device enables automatic voucher redemption for the client device.

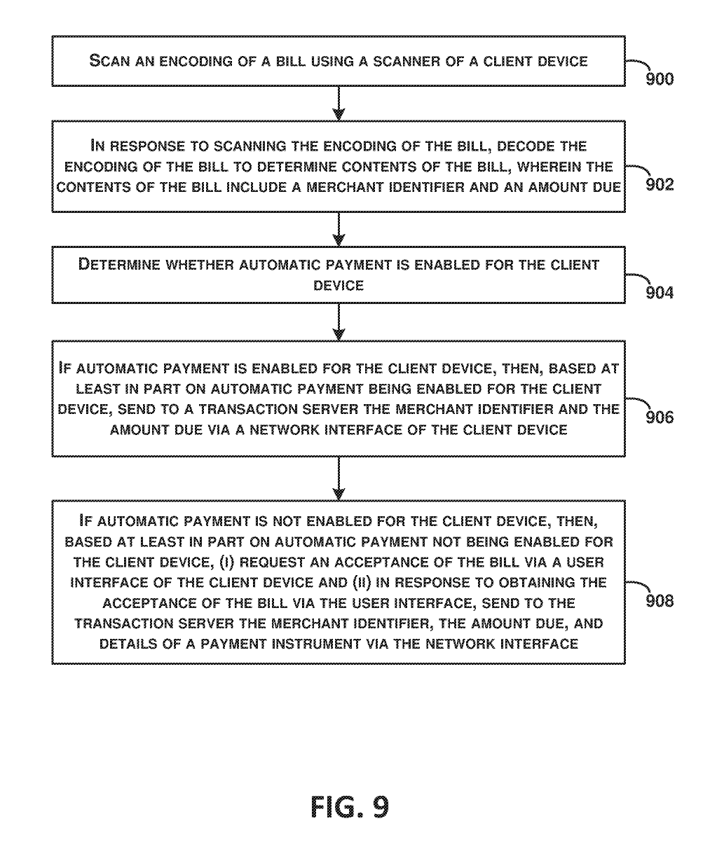

Next, FIG. 9 depicts a flow chart showing a set of operations that can, for example, be carried out using a client device, such as the client device 106. Several of the operations described in connection with FIG. 9 parallel operations described in connection with FIGS. 5, 6A, and 6B. As such, variations of the operations described in connection with FIGS. 5, 6A, and 6B are likewise applicable to the operations described in connection with FIG. 9. However, for the sake of brevity, these variations are not repeated.

Initially, block 900 includes scanning an encoding of a bill using a scanner of a client device.

Next, block 902 includes, in response to scanning the encoding of the bill, decoding the encoding of the bill to determine contents of the bill. The contents of the bill include a merchant identifier and an amount due. The contents of the bill can also include a bill identifier.

Next, block 904 includes determining whether automatic payment is enabled for the client device. In some embodiments, determining whether automatic payment is enabled for the client device can include determining whether a user of the client device has configured the client device for automatic payment of bills from merchants.

Next, block 906 includes, if automatic payment is enabled for the client device, then, based at least in part on automatic payment being enabled for the client device, sending to a transaction server the merchant identifier and the amount due via a network interface of the client device. In an embodiment in which the contents of the bill also include a bill identifier, the client device can, at block 906, also send the bill identifier to the transaction server via the network interface.

Next, block 908 includes, if automatic payment is not enabled for the client device, then, based at least in part on automatic payment not being enabled for the client device, (i) requesting an acceptance of the bill via a user interface of the client device and (ii) in response to obtaining the acceptance of the bill via the user interface, sending to the transaction server the merchant identifier, the amount due, and details of a payment instrument via the network interface. In some embodiments, requesting the acceptance of the bill includes displaying at least the amount due on the client device. In some embodiments, requesting the acceptance of the bill includes requesting a selection of a payment instrument, and obtaining the acceptance of the bill includes receiving a selection of the payment instrument via the user interface. In an embodiment in which the contents of the bill also include a bill identifier, the client device can, at block 708, also send the bill identifier to the transaction server via the network interface.

In some embodiments, if automatic payment is enabled for the client device, then the client device may determine whether an automatic payment limit is set for the client device. If the automatic payment limit is set, then the client device may determine whether the amount due exceeds the automatic payment limit. If the amount due does not exceed the automatic payment limit, the client device sends the merchant identifier and the amount due to the transaction server via the network interface at least partially in response to a determination that the amount due does not exceed the automatic payment limit. Whereas, if the amount due exceeds the automatic payment limit, the client device requests the acceptance of the bill via the user interface at least partially in response to a determination that the amount due exceeds the automatic payment limit. On the other hand, if the automatic payment limit is not set, the client device sends the merchant identifier and the amount due to the transaction server via the network interface at least partially in response to a determination that the automatic payment limit is not set.

In some embodiments, if automatic payment is enabled for the client device, then the client device may determine whether an automatic payment limit is set for the client device. If the automatic payment limit is set, then the client device may determine whether the amount due exceeds the automatic payment limit. If the amount due does not exceed the automatic payment limit, the client device sends the merchant identifier and the amount due to the transaction server via the network interface at least partially in response to a determination that the amount due does not exceed the automatic payment limit. Whereas, if the amount due exceeds the automatic payment limit, the client device requests an override password and sends the merchant identifier and the amount due to the transaction server via the network interface at least partially in response to a verification of a received override password. On the other hand, if the automatic payment limit is not set, the client device sends the merchant identifier and the amount due to the transaction server via the network interface at least partially in response to a determination that the automatic payment limit is not set.

In some embodiments, if automatic payment is enabled for the client device, then the client device may determine whether an automatic payment limit is set for the client device. If the automatic payment limit is set, then the client device may determine whether the amount due exceeds the automatic payment limit. If the amount due does not exceed the automatic payment limit, the client device sends the merchant identifier and the amount due to the transaction server via the network interface at least partially in response to a determination that the amount due does not exceed the automatic payment limit. Whereas, if the amount due exceeds the automatic payment limit, the client device prompts a user to confirm the payment request and sends the merchant identifier and the amount due to the transaction server via the network interface at least partially in response to receiving a confirmation of the payment request. On the other hand, if the automatic payment limit is not set, the client device sends the merchant identifier and the amount due to the transaction server via the network interface at least partially in response to a determination that the automatic payment limit is not set.

In some embodiments, if automatic payment is enabled for the client device, then the client device may determine whether automatic voucher redemption is enabled for the client device. If automatic voucher redemption is enabled for the client device, then the client device may determine whether there is a qualifying voucher stored on the client device. The qualifying voucher may be a voucher that can be applied toward the bill. If there is a qualifying voucher stored on the client device, the client device determines a reduced balance due by applying the qualifying voucher to the amount due and sends the merchant identifier, the amount due, the reduced balance due, and a voucher identifier of the qualifying voucher to the transaction sever via the network interface at least partially in response to a determination that there is a qualifying voucher stored on the client device. Whereas, if there is not a qualifying voucher stored on the client device, the client device sends the merchant identifier and the amount due to the transaction server via the network interface at least partially in response to a determination that there is not a qualifying voucher stored on the client device. On the other hand, if automatic voucher redemption is not enabled, the client device sends the merchant identifier and the amount due to the transaction server via the network interface at least partially in response to a determination that automatic voucher redemption is not enabled.

In some embodiments, after obtaining the acceptance of the bill and sending to the transaction server the merchant identifier, the amount due, and the details of the payment instrument, the client device can receive from the transaction server via the network interface a notification that the bill is paid. Further, in response to receiving the notification that the bill is paid, the client device prompts a user of the client device to enable automatic payment for the client device.

In some embodiments, the client device receives via the user interface a request to activate automatic payment. In response to receiving the request to activate automatic payment, the client device then requests a selection of a default payment instrument. After obtaining via the user interface a selection of the default payment instrument, the client device enables automatic payment on the client device via the default payment instrument and sends to the transaction server via the network interface details of the default payment instrument. With this arrangement, the details of the default payment instrument need not be sent to the transaction server at the time of automatic payment transactions.

### VII. Additional Example Embodiments

Therefore, from one perspective, there has been described that a client device may scan an encoding of a bill using a scanner. In response to scanning the encoding of the bill, the client device may decode the encoding of the bill to determine contents of the bill, including a merchant identifier and an amount due. The client device may determine whether automatic payment is enabled for the client device. If automatic payment is enabled for the client device, the client device may send to a transaction server the merchant identifier, the amount due, and details of a preselected payment instrument. If automatic payment is not enabled for the client device, then the client device may request an acceptance of the bill via a user interface and, in response to obtaining the acceptance of the bill, the client device may send to the transaction server the merchant identifier, the amount due, and details of a payment instrument.

The following clauses are offered as further description of the disclosed embodiments.

(1) A method, performed by a client device, to pay a bill from a merchant, wherein the client device and the merchant use a transaction server to facilitate payment of the bill, and wherein the client device comprises a scanner, a network interface, and a user interface, the method comprising:

scanning an encoding of the bill using the scanner;

in response to scanning the encoding of the bill, decoding the encoding of the bill to determine contents of the bill, wherein the contents of the bill comprise a merchant identifier and an amount due;

determining whether automatic payment is enabled for the client device;

if automatic payment is enabled for the client device, then, based at least in part on automatic payment being enabled for the client device, sending to the transaction server the merchant identifier, the amount due, and details of a preselected payment instrument via the network interface; and

if automatic payment is not enabled for the client device, then, based at least in part on automatic payment not being enabled for the client device, (i) requesting an acceptance of the bill via the user interface and (ii) in response to obtaining the acceptance of the bill via the user interface, sending to the transaction server the merchant identifier, the amount due, and details of a payment instrument via the network interface.

(2) The method of clause (1), wherein determining whether automatic payment is enabled for the client device comprises determining whether a user of the client device has configured the client device for automatic payment of bills from merchants.

(3) The method of any of clauses (1)-(2), further comprising:

if automatic payment is enabled for the client device, then, determining whether an automatic payment limit is set for the client device; and

if the automatic payment limit is set, then determining whether the amount due exceeds the automatic payment limit;

wherein if automatic payment is enabled and the amount due does not exceed the automatic payment limit, the merchant identifier, the amount due, and the details of the preselected payment instrument are sent to the transaction server via the network interface at least partially in response to a determination that the amount due does not exceed the automatic payment limit,

wherein if automatic payment is enabled and the amount due exceeds the automatic payment limit, the acceptance of the bill is requested via the user interface at least partially in response to a determination that the amount due exceeds the automatic payment limit, and

wherein if automatic payment is enabled and the automatic payment limit is not set, the merchant identifier, the amount due, and the details of the preselected payment instrument are sent to the transaction server via the network interface at least partially in response to a determination that the automatic payment limit is not set.

(4) The method of any of clauses (1)-(2), further comprising:

if automatic payment is enabled for the client device, then determining whether an automatic payment limit is set for the client device;

if the automatic payment limit is set, then determining whether the amount due exceeds the automatic payment limit; and

if the amount due exceeds the automatic payment limit, requesting an override password,

wherein if automatic payment is enabled and the amount due does not exceed the automatic payment limit, the merchant identifier, the amount due, and the details of the preselected payment instrument are sent to the transaction server via the network interface at least partially in response to a determination that the amount due does not exceed the automatic payment limit,

wherein if automatic payment is enabled and the amount due exceeds the automatic payment limit, the merchant identifier, the amount due, and the details of the preselected payment instrument are sent to the transaction server via the network interface at least partially in response to a verification of a received override password, wherein the override password is received via the user interface, and

wherein if automatic payment is enabled and the automatic payment limit is not set, the merchant identifier, the amount due, and the details of the preselected payment instrument are sent to the transaction server via the network interface at least partially in response to a determination that the automatic payment limit is not set.

(5) The method of any of clauses (1)-(2), further comprising:

if automatic payment is enabled for the client device, then determining whether an automatic payment limit is set for the client device;

if the automatic payment limit is set, then determining whether the amount due exceeds the automatic payment limit; and

if the amount due exceeds the automatic payment limit, prompting a user to confirm the payment request,

wherein if automatic payment is enabled and the amount due does not exceed the automatic payment limit, the merchant identifier, the amount due, and the details of the preselected payment instrument are sent to the transaction server via the network interface at least partially in response to a determination that the amount due does not exceed the automatic payment limit,

wherein if automatic payment is enabled and the amount due exceeds the automatic payment limit, the merchant identifier, the amount due, and the details of the preselected payment instrument are sent to the transaction server via the network interface at least partially in response to receiving a confirmation of the payment request, and

wherein if automatic payment is enabled and the automatic payment limit is not set, the merchant identifier, the amount due, and the details of the preselected payment instrument are sent to the transaction server via the network interface at least partially in response to a determination that the automatic payment limit is not set.

(6) The method of any of clauses (1)-(5), further comprising:

if automatic payment is enabled for the client device, then, determining whether automatic voucher redemption is enabled for the client device;

if automatic voucher redemption is enabled for the client device, then determining whether there is a qualifying voucher stored on the client device, wherein the qualifying voucher is a voucher that can be applied toward the bill; and

if there is a qualifying voucher stored on the client device, determining a reduced balance due by applying the qualifying voucher to the amount due;

wherein if automatic payment is enabled and there is a qualifying voucher stored on the client device, the merchant identifier, the amount due, the reduced balance due, a voucher identifier of the qualifying voucher, and the details of the preselected payment instrument are sent to the transaction server via the network interface at least partially in response to a determination that there is a qualifying voucher stored on the client device,

wherein if automatic payment is enabled and there is not a qualifying voucher stored on the client device, the merchant identifier, the amount due, and the details of the preselected payment instrument are sent to the transaction server via the network interface at least partially in response to a determination that there is not a qualifying voucher stored on the client device, and

wherein if automatic payment is enabled and automatic voucher redemption is not enabled, the merchant identifier, the amount due, and the details of the preselected payment instrument are sent to the transaction server via the network interface at least partially in response to a determination that automatic voucher redemption is not enabled.

(7) The method of any of clauses (1)-(6), wherein requesting the acceptance of the bill comprises displaying at least the amount due.

(8) The method of any of clauses (1)-(7), wherein requesting the acceptance of the bill comprises requesting a selection of a payment instrument, and wherein obtaining the acceptance of the bill comprises receiving a selection of the payment instrument via the user interface.

(9) The method of any of clauses (1)-(8), wherein the contents of the bill further comprise a bill identifier, and wherein the method further comprises:

if automatic payment is enabled for the client device, then, based at least in part on automatic payment being enabled for the client device, sending the bill identifier to the transaction server via the network interface; and

if automatic payment is not enabled for the client device, then, based at least in part on automatic payment not being enabled for the client device, (i) requesting an acceptance of the bill via the user interface and (ii) in response to obtaining the acceptance of the bill via the user interface, sending to the transaction server the bill identifier.

(10) The method of any of clauses (1)-(9), further comprising:

after obtaining the acceptance of the bill and sending to the transaction server the merchant identifier, the amount due, and the details of the payment instrument, receiving from the transaction server via the network interface a notification that the bill is paid; and

in response to receiving the notification that the bill is paid, prompting a user of the client device to enable automatic payment for the client device.

(11) The method of clause (10), wherein prompting the user of the client device to enable automatic payment comprises prompting the user of the client device to: enable automatic payment for the client device and select the payment instrument as a designated payment instrument for automatic payment.

(12) The method of clause (10), further comprising:

in response to receiving the notification that the bill is paid, determining a device-specific automatic payment limit based on a payment history of the client device,

wherein prompting the user of the client device to enable automatic payment for the client device comprises prompting the user of the client device to: enable automatic payment for the client device and set the device-specific payment limit as the automatic payment limit.

(13) The method of clause (12), wherein the payment history of the client device comprises a payment history of the client device via the payment instrument, and wherein prompting the user of the client device to enable automatic payment for the client device comprises prompting the user of the client device to: enable automatic payment for the client device, select the payment instrument as a designated payment instrument, and set the device-specific payment limit as the automatic payment limit.

(14) The method of any of clauses (1)-(13), further comprising:

receiving via the user interface a request to activate automatic payment;

in response to receiving the request to activate automatic payment, requesting a selection of a default payment instrument;

obtaining via the user interface a selection of the preselected payment instrument as the default payment instrument; and

enabling automatic payment on the client device via the preselected payment instrument.

(15) The method of clause (14), further comprising:

receiving via the user interface a payment limit for automatic payment on the client device; and

in response to receiving the payment limit, setting the payment limit as the automatic payment limit.

(16) The method of clause (15), further comprising:

in response to receiving the payment limit, requesting a designation of an override password, wherein the override password is a password required to authorize an automatic payment that exceeds the automatic payment limit; and

in response to obtaining a password via the user interface, setting the password as the override password.

(17) The method of any of clauses (1)-(16), further comprising:

receiving via the user interface a request to activate automatic voucher redemption; and

in response to receiving the request to activate automatic voucher redemption, enabling automatic voucher redemption for the client device.

(18) An article of manufacture including a non-transitory computer-readable medium, having stored thereon program instructions that, upon execution by a computing device, cause the computing device to perform the operations of any one or more of clauses (1)-(17).

(19) A computing device, comprising at least one processor, and a memory having stored thereon program instructions executable by the at least one processor to perform the operations of any one or more of clauses (1)-(17).

(20) A method, performed by a client device, to enable the client device to automatically pay bills from merchants, wherein the client device comprises a scanner, a network interface, and a user interface, the method comprising:

scanning an encoding of a bill using the scanner;

in response to scanning the encoding of the bill, decoding the encoding of the bill to determine contents of the bill, wherein the contents of the bill comprise a merchant identifier and an amount due;

requesting an acceptance of the bill via the user interface;

in response to obtaining the acceptance of the bill via the user interface, sending to a transaction server the merchant identifier, the amount due, and details of a payment instrument via the network interface;

receiving, from the transaction server via the network interface, a notification that the bill is paid; and

in response to receiving the notification that the bill is paid, prompting a user of the client device via the user interface to enable automatic payment for the client device.

(21) The method of clause (20), wherein prompting the user of the client device via the user interface to enable automatic payment comprises prompting the user of the client device via the user interface to: enable automatic payment for the client device and select the payment instrument as a designated payment instrument for automatic payment.

(22) The method of clause (20), further comprising:

in response to receiving the notification that the bill is paid, determining a device-specific automatic payment limit based on a payment history of the client device,

wherein prompting the user of the client device via the user interface to enable automatic payment for the client device comprises prompting the user of the client device via the user interface to: enable automatic payment for the client device and set the device-specific payment limit as the automatic payment limit.

(23) The method of clause (22), wherein the payment history of the client device comprises a payment history of the client device via the payment instrument, and wherein prompting the user of the client device via the user interface to enable automatic payment for the client device comprises prompting the user of the client device via the user interface to: enable automatic payment for the client device, select the payment instrument as a designated payment instrument, and set the device-specific payment limit as the automatic payment limit.

(24) The method of any of clauses (20)-(23), further comprising:

in response to receiving via the user interface a request to enable automatic payment, enabling automatic payment for the client device.

(25) The method of any of clauses (20)-(23), further comprising:

in response to receiving via the user interface a request to enable automatic payment, requesting a selection of a default payment instrument via the user interface; and

in response to obtaining the selection of the default payment instrument via the user interface, enabling automatic payment on the client device via the selected default payment instrument.

(26) The method of clause (24) or (25), further comprising:

receiving via the user interface a payment limit for automatic payment on the client device; and

in response to receiving the payment limit, setting the payment limit as the automatic payment limit.

(27) The method of clause (26), further comprising:

in response to receiving the payment limit, requesting a designation of an override password via the user interface, wherein the override password is a password required to authorize an automatic payment that exceeds the automatic payment limit; and

in response to obtaining a password via the user interface, setting the password as the override password.

(28) The method of any of clauses (20)-(27), further comprising:

receiving via the user interface a request to activate automatic voucher redemption; and

in response to receiving the request to activate automatic voucher redemption, enabling automatic voucher redemption for the client device.

(29) An article of manufacture including a non-transitory computer-readable medium, having stored thereon program instructions that, upon execution by a computing device, cause the computing device to perform the operations of any one or more of clauses (20)-(28).

(30) A computing device, comprising at least one processor, and a memory having stored thereon program instructions executable by the at least one processor to perform the operations of any one or more of clauses (20)-(28).

(31) A method, performed by a client device, to pay a bill from a merchant, wherein the client device and the merchant use a transaction server to facilitate payment of the bill, and wherein the client device comprises a scanner, a network interface, and a user interface, the method comprising:

scanning an encoding of the bill using the scanner;

in response to scanning the encoding of the bill, decoding the encoding of the bill to determine contents of the bill, wherein the contents of the bill comprise a merchant identifier and an amount due;

determining whether automatic payment is enabled for the client device;

if automatic payment is enabled for the client device, then, based at least in part on automatic payment being enabled for the client device, sending to the transaction server the merchant identifier and the amount due via the network interface; and

if automatic payment is not enabled for the client device, then, based at least in part on automatic payment not being enabled for the client device, (i) requesting an acceptance of the bill via the user interface and (ii) in response to obtaining the acceptance of the bill via the user interface, sending to the transaction server the merchant identifier, the amount due, and details of a payment instrument via the network interface.

(32) The method of clause (31), wherein determining whether automatic payment is enabled for the client device comprises determining whether a user of the client device has configured the client device for automatic payment of bills from merchants.

(33) The method of any of clauses (31)-(32), further comprising:

if automatic payment is enabled for the client device, then determining whether an automatic payment limit is set for the client device; and

if the automatic payment limit is set, then determining whether the amount due exceeds the automatic payment limit;

wherein if automatic payment is enabled and the amount due does not exceed the automatic payment limit, the merchant identifier and the amount due are sent to the transaction server via the network interface at least partially in response to a determination that the amount due does not exceed the automatic payment limit,

wherein if automatic payment is enabled and the amount due exceeds the automatic payment limit, the acceptance of the bill is requested via the user interface at least partially in response to a determination that the amount due exceeds the automatic payment limit, and

wherein if automatic payment is enabled and the automatic payment limit is not set, the merchant identifier and the amount due are sent to the transaction server via the network interface at least partially in response to a determination that the automatic payment limit is not set.

(34) The method of any of clauses (31)-(32), further comprising:

if automatic payment is enabled for the client device, then determining whether an automatic payment limit is set for the client device;

if the automatic payment limit is set, then determining whether the amount due exceeds the automatic payment limit; and

if the amount due exceeds the automatic payment limit, requesting an override password,

wherein if automatic payment is enabled and the amount due does not exceed the automatic payment limit, the merchant identifier and the amount due are sent to the transaction server via the network interface at least partially in response to a determination that the amount due does not exceed the automatic payment limit,

wherein if automatic payment is enabled and the amount due exceeds the automatic payment limit, the merchant identifier and the amount due are sent to the transaction server via the network interface at least partially in response to a verification of a received override password, wherein the override password is received via the user interface, and

wherein if automatic payment is enabled and the automatic payment limit is not set, the merchant identifier and the amount due are sent to the transaction server via the network interface at least partially in response to a determination that the automatic payment limit is not set.

(35) The method of any of clauses (31)-(32), further comprising:

if automatic payment is enabled for the client device, then, determining whether an automatic payment limit is set for the client device;

if the automatic payment limit is set, then determining whether the amount due exceeds the automatic payment limit; and

if the amount due exceeds the automatic payment limit, prompting a user to confirm the payment request,

wherein if automatic payment is enabled and the amount due does not exceed the automatic payment limit, the merchant identifier and the amount due are sent to the transaction server via the network interface at least partially in response to a determination that the amount due does not exceed the automatic payment limit,

wherein if automatic payment is enabled and the amount due exceeds the automatic payment limit, the merchant identifier and the amount due are sent to the transaction server via the network interface at least partially in response to receiving a confirmation of the payment request, and

wherein if automatic payment is enabled and the automatic payment limit is not set, the merchant identifier and the amount due are sent to the transaction server via the network interface at least partially in response to a determination that the automatic payment limit is not set.

(36) The method of any of clauses (31)-(35), further comprising:

if automatic payment is enabled for the client device, then, determining whether automatic voucher redemption is enabled for the client device;

if automatic voucher redemption is enabled for the client device, then determining whether there is a qualifying voucher stored on the client device, wherein the qualifying voucher is a voucher that can be applied toward the bill; and

if there is a qualifying voucher stored on the client device, determining a reduced balance due by applying the qualifying voucher to the amount due;

wherein if automatic payment is enabled and there is a qualifying voucher stored on the client device, the merchant identifier, the amount due, the reduced balance due, and a voucher identifier of the qualifying voucher, are sent to the transaction server via the network interface at least partially in response to a determination that there is a qualifying voucher stored on the client device,

wherein if automatic payment is enabled and there is not a qualifying voucher stored on the client device, the merchant identifier and the amount due are sent to the transaction server via the network interface at least partially in response to a determination that there is not a qualifying voucher stored on the client device, and

wherein if automatic payment is enabled and automatic voucher redemption is not enabled, the merchant identifier and the amount due are sent to the transaction server via the network interface at least partially in response to a determination that automatic voucher redemption is not enabled.

(37) The method of any of clauses (31)-(36), wherein requesting the acceptance of the bill comprises displaying at least the amount due.

(38) The method of any of clauses (31)-(37), wherein requesting the acceptance of the bill comprises requesting a selection of a payment instrument, and wherein obtaining the acceptance of the bill comprises receiving a selection of the payment instrument via the user interface.

(39) The method of any of clauses (31)-(38), wherein the contents of the bill further comprise a bill identifier, and wherein the method further comprises:

if automatic payment is enabled for the client device, then, based at least in part on automatic payment being enabled for the client device, sending the bill identifier to the transaction server via the network interface; and

if automatic payment is not enabled for the client device, then, based at least in part on automatic payment not being enabled for the client device, (i) requesting an acceptance of the bill via the user interface and (ii) in response to obtaining the acceptance of the bill via the user interface, sending to the transaction server the bill identifier.

(40) The method of any of clauses (31)-(39), further comprising:

receiving via the user interface a request to activate automatic payment;

in response to receiving the request to activate automatic payment, requesting a selection of a default payment instrument;

obtaining via the user interface a selection of the default payment instrument;

enabling automatic payment on the client device via the default payment instrument; and

sending to the transaction server via the network interface details of the default payment instrument.

(41) An article of manufacture including a non-transitory computer-readable medium, having stored thereon program instructions that, upon execution by a computing device, cause the computing device to perform the operations of any one or more of clauses (31)-(40).

(42) A computing device, comprising at least one processor, and a memory having stored thereon program instructions executable by the at least one processor to perform the operations of any one or more of clauses (31)-(40).

### VIII. Conclusion

This detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be used, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including in substantially concurrent or in reverse order, depending on the functionality involved. Further, more or fewer steps, blocks and/or functions can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk or hard drive or other storage media.

The computer-readable medium can include non-transitory computer-readable media such as computer-readable media that stores data for short periods of time like register memory, processor cache, and/or random access memory (RAM). The computer-readable media can include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media can be any other volatile or non-volatile storage systems. A computer-readable medium can be considered a computer-readable storage medium, for example, or a tangible storage device.

Software for use in carrying out the presently disclosed approaches can also be in transitory form, for example in the form of signals transmitted over a network such as the Internet. Moreover, a step or block that represents one or more information transmissions can correspond to information transmissions between software and/or hardware modules in the same physical device. However, other information transmissions can be between software modules and/or hardware modules in different physical devices.

Further, the described operations throughout this application need not be performed in the disclosed order, although in some examples, the recited order may be preferred. Also, not all operations need to be performed to achieve the desired advantages of disclosed machines and methods, and therefore not all operations are required.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

1. A method, performed by a client device, to pay a bill from a merchant, wherein the client device and the merchant use a transaction server to facilitate payment of the bill, and wherein the client device comprises a scanner, a network interface, and a user interface, the method comprising:
scanning an encoding of the bill using the scanner;
in response to scanning the encoding of the bill, decoding the encoding of the bill to determine contents of the bill, wherein the contents of the bill comprise a merchant identifier and an amount due;
determining whether automatic payment is enabled for the client device;
if automatic payment is enabled for the client device, then, based at least in part on automatic payment being enabled for the client device, sending to the transaction server the merchant identifier, the amount due, and details of a preselected payment instrument via the network interface; and
if automatic payment is not enabled for the client device, then, based at least in part on automatic payment not being enabled for the client device, (i) requesting an acceptance of the bill via the user interface and (ii) in response to obtaining the acceptance of the bill via the user interface, sending to the transaction server the merchant identifier, the amount due, and details of a payment instrument via the network interface.

2. The method of claim 1, wherein determining whether automatic payment is enabled for the client device comprises determining whether a user of the client device has configured the client device for automatic payment of bills from merchants.

3. The method of claim 1, further comprising:
if automatic payment is enabled for the client device, then determining whether an automatic payment limit is set for the client device; and
if the automatic payment limit is set, then determining whether the amount due exceeds the automatic payment limit;
wherein if automatic payment is enabled and the amount due does not exceed the automatic payment limit, the merchant identifier, the amount due, and the details of the preselected payment instrument are sent to the transaction server via the network interface at least partially in response to a determination that the amount due does not exceed the automatic payment limit,
wherein if automatic payment is enabled and the amount due exceeds the automatic payment limit, the acceptance of the bill is requested via the user interface at least partially in response to a determination that the amount due exceeds the automatic payment limit, and
wherein if automatic payment is enabled and the automatic payment limit is not set, the merchant identifier, the amount due, and the details of the preselected payment instrument are sent to the transaction server via the network interface at least partially in response to a determination that the automatic payment limit is not set.

4. The method of claim 1, further comprising:
if automatic payment is enabled for the client device, then determining whether an automatic payment limit is set for the client device;
if the automatic payment limit is set, then determining whether the amount due exceeds the automatic payment limit; and
if the amount due exceeds the automatic payment limit, requesting an override password,
wherein if automatic payment is enabled and the amount due does not exceed the automatic payment limit, the merchant identifier, the amount due, and the details of the preselected payment instrument are sent to the transaction server via the network interface at least partially in response to a determination that the amount due does not exceed the automatic payment limit,
wherein if automatic payment is enabled and the amount due exceeds the automatic payment limit, the merchant identifier, the amount due, and the details of the preselected payment instrument are sent to the transaction server via the network interface at least partially in response to a verification of a received override password, wherein the override password is received via the user interface, and
wherein if automatic payment is enabled and the automatic payment limit is not set, the merchant identifier, the amount due, and the details of the preselected payment instrument are sent to the transaction server via the network interface at least partially in response to a determination that the automatic payment limit is not set.

5. The method of claim 1, further comprising:
if automatic payment is enabled for the client device, then, determining whether an automatic payment limit is set for the client device;
if the automatic payment limit is set, then determining whether the amount due exceeds the automatic payment limit; and
if the amount due exceeds the automatic payment limit, prompting a user to confirm the payment request,
wherein if automatic payment is enabled and the amount due does not exceed the automatic payment limit, the merchant identifier, the amount due, and the details of the preselected payment instrument are sent to the transaction server via the network interface at least partially in response to a determination that the amount due does not exceed the automatic payment limit,
wherein if automatic payment is enabled and the amount due exceeds the automatic payment limit, the merchant identifier, the amount due, and the details of the preselected payment instrument are sent to the transaction server via the network interface at least partially in response to receiving a confirmation of the payment request, and
wherein if automatic payment is enabled and the automatic payment limit is not set, the merchant identifier, the amount due, and the details of the preselected payment instrument are sent to the transaction server via the network interface at least partially in response to a determination that the automatic payment limit is not set.

6. The method of claim 1, further comprising:
if automatic payment is enabled for the client device, then, determining whether automatic voucher redemption is enabled for the client device;
if automatic voucher redemption is enabled for the client device, then determining whether there is a qualifying voucher stored on the client device, wherein the qualifying voucher is a voucher that can be applied toward the bill; and
if there is a qualifying voucher stored on the client device, determining a reduced balance due by applying the qualifying voucher to the amount due;
wherein if automatic payment is enabled and there is a qualifying voucher stored on the client device, the merchant identifier, the amount due, the reduced balance due, a voucher identifier of the qualifying voucher, and the details of the preselected payment instrument are sent to the transaction server via the network interface at least partially in response to a determination that there is a qualifying voucher stored on the client device,
wherein if automatic payment is enabled and there is not a qualifying voucher stored on the client device, the merchant identifier, the amount due, and the details of the preselected payment instrument are sent to the transaction server via the network interface at least partially in response to a determination that there is not a qualifying voucher stored on the client device, and
wherein if automatic payment is enabled and automatic voucher redemption is not enabled, the merchant identifier, the amount due, and the details of the preselected payment instrument are sent to the transaction server via the network interface at least partially in response to a determination that automatic voucher redemption is not enabled.

7. The method of claim 1, wherein requesting the acceptance of the bill comprises displaying at least the amount due.

8. The method of claim 1, wherein requesting the acceptance of the bill comprises requesting a selection of a payment instrument, and wherein obtaining the acceptance of the bill comprises receiving a selection of the payment instrument via the user interface.

9. The method of claim 1, wherein the contents of the bill further comprise a bill identifier, and wherein the method further comprises:
if automatic payment is enabled for the client device, then, based at least in part on automatic payment being enabled for the client device, sending the bill identifier to the transaction server via the network interface; and
if automatic payment is not enabled for the client device, then, based at least in part on automatic payment not being enabled for the client device, (i) requesting an acceptance of the bill via the user interface and (ii) in response to obtaining the acceptance of the bill via the user interface, sending to the transaction server the bill identifier.

10. The method of claim 1, further comprising:
after obtaining the acceptance of the bill and sending to the transaction server the merchant identifier, the amount due, and the details of the payment instrument, receiving from the transaction server via the network interface a notification that the bill is paid; and
in response to receiving the notification that the bill is paid, prompting a user of the client device to enable automatic payment for the client device.

11. The method of claim 10, wherein prompting the user of the client device to enable automatic payment comprises prompting the user of the client device to: enable automatic payment for the client device and select the payment instrument as a designated payment instrument for automatic payment.

12. The method of claim 10, further comprising:
in response to receiving the notification that the bill is paid, determining a device-specific automatic payment limit based on a payment history of the client device,
wherein prompting the user of the client device to enable automatic payment for the client device comprises prompting the user of the client device to: enable automatic payment for the client device and set the device-specific payment limit as the automatic payment limit.

13. The method of claim 12, wherein the payment history of the client device comprises a payment history of the client device via the payment instrument, and wherein prompting the user of the client device to enable automatic payment for the client device comprises prompting the user of the client device to: enable automatic payment for the client device, select the payment instrument as a designated payment instrument, and set the device-specific payment limit as the automatic payment limit.

14. The method of claim 1, further comprising:
receiving via the user interface a request to activate automatic payment;
in response to receiving the request to activate automatic payment, requesting a selection of a default payment instrument;
obtaining via the user interface a selection of the preselected payment instrument as the default payment instrument; and
enabling automatic payment on the client device via the preselected payment instrument.

15. The method of claim 14, further comprising:
receiving via the user interface a payment limit for automatic payment on the client device; and
in response to receiving the payment limit, setting the payment limit as the automatic payment limit.

16. The method of claim 15, further comprising:
in response to receiving the payment limit, requesting a designation of an override password, wherein the override password is a password required to authorize an automatic payment that exceeds the automatic payment limit; and
in response to obtaining a password via the user interface, setting the password as the override password.

17. The method of claim 1, further comprising:
receiving via the user interface a request to activate automatic voucher redemption; and
in response to receiving the request to activate automatic voucher redemption, enabling automatic voucher redemption for the client device.

18. An article of manufacture including a non-transitory computer-readable medium, having stored thereon program instructions that, upon execution by a computing device, cause the computing device to perform operations comprising:
scanning an encoding of a bill from a merchant using a scanner of a client device;
in response to scanning the encoding of the bill, decoding the encoding of the bill to determine contents of the bill, wherein the contents of the bill comprise a merchant identifier and an amount due;
determining whether automatic payment is enabled for the client device;
if automatic payment is enabled for the client device, then, based at least in part on automatic payment being enabled for the client device, sending to a transaction server the merchant identifier, the amount due, and details of a preselected payment instrument via a network interface of the client device; and
if automatic payment is not enabled for the client device, then, based at least in part on automatic payment not being enabled for the client device, (i) requesting an acceptance of the bill via a user interface of the client device and (ii) in response to obtaining the acceptance of the bill via the user interface, sending to the transaction server the merchant identifier, the amount due, and details of a payment instrument via the network interface.

19. A computing device, comprising at least one processor, and a memory having stored thereon program instructions executable by the at least one processor to perform operations comprising:
scanning an encoding of a bill from a merchant using a scanner of a client device;
in response to scanning the encoding of the bill, decoding the encoding of the bill to determine contents of the bill, wherein the contents of the bill comprise a merchant identifier and an amount due;
determining whether automatic payment is enabled for the client device;
if automatic payment is enabled for the client device, then, based at least in part on automatic payment being enabled for the client device, sending to a transaction server the merchant identifier, the amount due, and details of a preselected payment instrument via a network interface of the client device; and
if automatic payment is not enabled for the client device, then, based at least in part on automatic payment not being enabled for the client device, (i) requesting an acceptance of the bill via a user interface of the client device and (ii) in response to obtaining the acceptance of the bill via the user interface, sending to the transaction server the merchant identifier, the amount due, and details of a payment instrument via the network interface.

20-41. (canceled)

42. The computing device of claim 19, wherein the operations further comprise:
if automatic payment is enabled for the client device, then determining whether an automatic payment limit is set for the client device; and
if the automatic payment limit is set, then determining whether the amount due exceeds the automatic payment limit;
wherein if automatic payment is enabled and the amount due does not exceed the automatic payment limit, the merchant identifier, the amount due, and the details of the preselected payment instrument are sent to the transaction server via the network interface at least partially in response to a determination that the amount due does not exceed the automatic payment limit,
wherein if automatic payment is enabled and the amount due exceeds the automatic payment limit, the acceptance of the bill is requested via the user interface at least partially in response to a determination that the amount due exceeds the automatic payment limit, and
wherein if automatic payment is enabled and the automatic payment limit is not set, the merchant identifier, the amount due, and the details of the preselected payment instrument are sent to the transaction server via the network interface at least partially in response to a determination that the automatic payment limit is not set.
